(19) United States
(12) Patent Application Publication
(10) Pub. No.: US 2025/0119942 A1
(43) Pub. Date: Apr. 10, 2025

(54) METHOD AND COMMUNICATION DEVICE FOR DETERMINING RANDOM ACCESS RESPONSE WINDOW

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 18/695,925

(22) PCT Filed: Sep. 30, 2021
(86) PCT No.: PCT/CN2021/122387

§ 371 Date: Mar. 27, 2024

(51) Int. Cl. H04W 74/0808

(52) U.S. Cl. CPC H04W 74/0808

(57) ABSTRACT

A method, apparatus and computer readable medium for determining a random access response window in a wireless communication systems such as a long term evolution (LTE) system, a 5th generation (5G) mobile communication system, a 5G new radio (NR) system, or other mobile communication systems. The random access response window is determined by: obtaining the number of repeated transmissions of a narrowband physical random access channel (NPRACH); obtaining a round-trip time (RTT) between a first device and a second device; and determining a start position of a random access response window.

### CROSS REFERENCE TO RELATED APPLICATIONS

The present application is a U.S. National Stage of International Application No. PCT/CN2021/122387 filed on Sep. 30, 2021, the content of which is incorporated herein by reference in its entirety.

### TECHNICAL FIELD

The present application relates to the field of communication technology and, in particular, to a method and communication devices for determining a random access response window.

### BACKGROUND

Satellite communication is considered an important aspect of future wireless communication technology development. Satellite communication refers to communication carried out by radio communication equipment on the ground using satellites as relays. A satellite communication system includes a satellite part and a ground part. The characteristics of satellite communication are: having a large communication range; allowing communication between any two points as long as the two points are within the range covered by the airwaves emitted by the satellite; and being less susceptible to land-based disasters (having high reliability).

In satellite communication, due to long signal transmission distance between terminal devices and network devices, it is resulted that data transmission takes a considerable amount of time. For communication involving a relationship between uplink and downlink transmission, the transmission delay is compensated by introducing timing offset Koffset. In determining an accurate random access response window (RA Response window), different scenarios may have different delay requirements for transmission needs, which may lead to unnecessary extra delay, thus increasing detection overhead and causing resource wastage.

### SUMMARY

Embodiments of the present application provide a method and communication devices for determining a random access response window, which can be applied to communication systems such as a long term evolution (LTE) system, a fifth generation (5G) mobile communication system, a 5G new radio (NR) system, or other new mobile communication systems in the future, etc. By using a number of repeated transmissions and round-trip time (RTT) of the narrowband physical random access channel (NPRACH) to determine a start position of the random access response window can avoid unnecessary additional delay, thus contributing to reducing the detection overhead and avoiding the resource wastage.

In a first aspect, an embodiment of the present application provides a method for determining a random access response window, including:
obtaining a number of repeated transmissions of a narrowband physical random access channel (NPRACH);
obtaining a round-trip time (RTT) between a first device and a second device; and
determining a start position of the random access response window.

In a second aspect, an embodiment of the present application provides a communication device including a processor and a memory in which a computer program is stored, the processor executing the computer program stored in the memory to cause the device to perform operations including: obtaining a number of repeated transmissions of a narrowband physical random access channel (NPRACH); obtaining a round-trip time (RTT) between a first device and a second device; and determining a start position of the random access response window.

In a third aspect, an embodiment of the present application provides a communication device including a processor and an interface circuit, the interface circuit being configured for receiving code instructions and transmitting the code instructions to the processor, the processor being configured for running the code instructions to perform operations including: obtaining a number of repeated transmissions of a narrowband physical random access channel (NPRACH); obtaining a round-trip time (RTT) between a first device and a second device; and determining a start position of the random access response window.

### BRIEF DESCRIPTION OF DRAWINGS

In order to more clearly illustrate technical solutions in the embodiments of the present application or the background, accompanying drawings to be used in the embodiments of the present application or the background are described below.

FIG. 1 is a schematic architectural diagram of a communication system provided by an embodiment of the present application;

FIG. 2 is a schematic diagram of uplink and downlink timing alignment in a base station provided by an embodiment of the present application;

FIG. 3 is a schematic diagram of uplink and downlink timing misalignment in a base station provided by an embodiment of the present application;

FIG. 4 is a schematic flowchart of a method for determining a random access response window provided by an embodiment of the present application;

FIG. 5 is a schematic flowchart of a method for determining a random access response window provided by an embodiment of the present application;

FIG. 6 is a schematic structural diagram of a communication device provided by an embodiment of the present application;

FIG. 7 is a schematic structural diagram of another communication device provided by an embodiment of the present application; and

FIG. 8 is a schematic structural diagram of a chip provided by an embodiment of the present application.

### DETAILED DESCRIPTION

For ease of understanding, the terminologies involved in this application are first introduced.

### 1. Non-Terrestrial Network (NTN)

NTN is a technology that adopts typical technologies such as using satellites and high-altitude platform station (HAPS) for network deployment, compared to traditional terrestrial networks. Taking satellite communication as an example, theoretically only three geostationary earth orbiting (GEO) satellites are needed to cover the global range except for the polar regions, which can realize a larger coverage at a lower cost.

### 2. Physical Random Access Channel (PRACH)

PRACH is a channel on which a terminal device initiates an uplink system access, and the terminal device may initiate a random access process on the PRACH either autonomously or based on instructions of the base station eNodeB.

In order to better understand methods for determining a random access response window disclosed by embodiments of the present application, a communication system which embodiments of the present application are applied to is first described below.

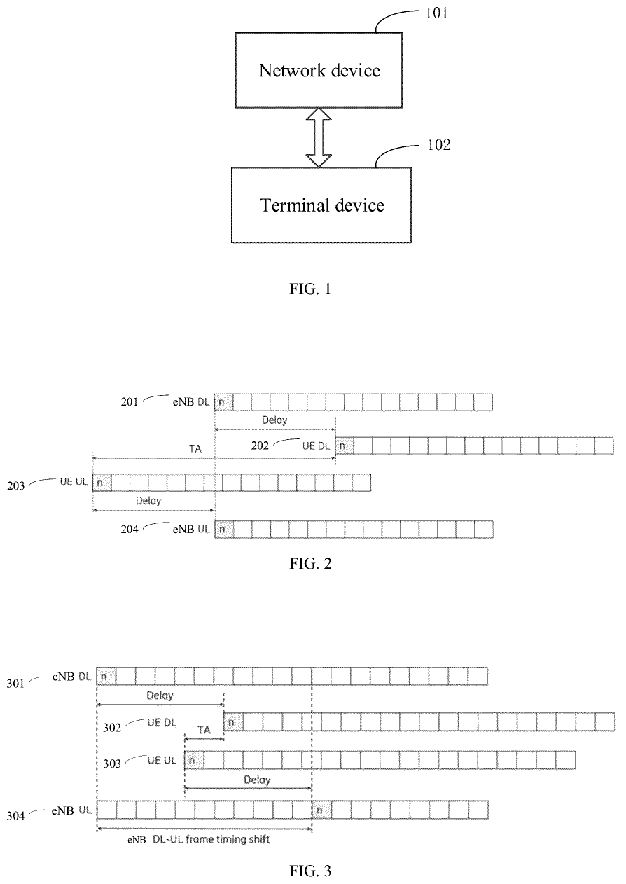

Referring to FIG. 1, FIG. 1 is a schematic architectural diagram of a communication system provided by an embodiment of the present application. The communication system may include, but is not limited to, a network device and a terminal device. The number and form of the devices shown in FIG. 1 are for example only and do not constitute a limitation of the embodiment of the present application. In an actual application, the communication system may include two or more network devices, and two or more terminal devices. As an example, the communication system shown in FIG. 1 includes a network device 101 and a terminal device 102.

It should be noted that the technical solutions of the embodiments of the present application can be applied to various communication systems, for example, a long-term evolution (LTE) system, a fifth generation (5G) mobile communication system, a 5G new radio (NR) system, or other new mobile communication systems in the future, etc. It is also noted that the sidelink in the embodiments of the present application may also be referred to as a side link or a direct link.

The network device 101 in the embodiment of the present application is a network entity for transmitting or receiving signals. For example, the network device 101 may be an evolved NodeB (eNB), a transmission reception point (TRP), a next generation NodeB (gNB) in an NR system, a base station in other future mobile communication systems, or an access point in wireless fidelity (WiFi) systems, etc. The embodiments of the present application do not limit the specific technology and the specific device form adopted by the network device. The network device provided in the embodiment of the present application may include a central unit (CU) and one or more distributed units (DU). The CU may also be called a control unit, and the structure of the CU-DU may allow for the separation of functions of the protocol layer in the network device, such as a base station. In this way, some of the functions of the protocol layer are distributed in the CU and controlled centrally by the CU, while all or a part of the remaining functions of the protocol layer are distributed in the DUs which are controlled centrally by the CU.

The terminal device 102 in the embodiment of the present application is a user entity for receiving or transmitting signals, such as a cellular phone. The terminal device may also be referred to as a terminal, a user equipment (UE), a mobile station (MS), a mobile terminal (MT), and the like. The terminal device can be a car with communication functions, an intelligent car, a mobile phone, a wearable device, a tablet computer (Pad), a computer with wireless transceiver functions, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, and so on. The embodiment of the present application does not limit the specific technology and the specific device form adopted by the terminal device.

The continuous emergence of augmented reality (AR), virtual reality (VR), vehicle-to-vehicle communication and other new Internet applications of the new generation put forward higher requirements for the wireless communication technology, driving the continuous evolution of wireless communication technology to meet the needs of applications. Nowadays, cellular mobile communication technology is in an evolution stage of a new generation technology. An important feature of the new generation technology is to support flexible configuration of multiple service types. Different service types have different requirements for the wireless communication technology. For example, an enhanced mobile broadband (eMBB) service type mainly focuses on requirements such as large bandwidth, high data rates, etc.; an ultra reliable low latency communication (URLLC) service type mainly focuses on requirements such as high reliability and low latency; a massive machine type communication (mMTC) service type mainly focuses on requirements such as a large number of connections. Therefore, wireless communication systems of the new generation need a flexible and configurable design to support the transmission of multiple service types.

In the study of wireless communication technology, satellite communication is considered to be an important aspect of the future development of the wireless communication technology. Satellite communication refers to the communication carried out by radio communication equipment on the ground using satellites as relays. A satellite communication system includes a satellite part and a ground part. The characteristics of the satellite communication are: having a large communication range; allowing communication between any two points as long as the two points are within the range covered by the airwaves emitted by the satellite; and being less susceptible to land-based disasters (having high reliability). The satellite communication can have the following benefits as a supplement to the current cellular communication systems on the ground:
(1) extended coverage: for areas that cannot be covered by the current cellular communication systems or where the cost of coverage is high, such as oceans, deserts, remote mountainous areas, etc., the problem of communication can be solved by satellite communication.
(2) emergency communications: the satellite communication can be used to quickly establish communication links in extreme situations such as earthquakes where cellular communication infrastructures are unavailable.
(3) providing industry applications: for example, for delay-sensitive services transmitted over long distances, the transmission delay of the services can be reduced by means of satellite communications.

It is foreseeable that in the future wireless communication systems, the satellite communication systems and the land-based cellular communication systems will gradually be deeply integrated and the internet of things will turn into reality.

For satellite communication scenarios, due to long signal transmission distance between a transmitter and a receiver, it is resulted that data transmission takes a considerable amount of time. For communication involving uplink and downlink transmission, the current standardization discussion determines the introduction of Koffset parameters to compensate for the transmission delay.

FIG. 2 is a schematic diagram of uplink and downlink timing alignment in a base station provided by an embodiment of the present application. As shown in FIG. 2, eNB DL 201 indicates a downlink communication in a base station, eNB UL 204 indicates an uplink communication in the base station, UE DL 202 indicates a downlink communication in a terminal, UE UL 203 indicates an uplink communication in the terminal, and n is a reference subframe (also referred to as a reference point). The reference point is located in the base station. In order to ensure that the reference point n in the eNB DL 201 and the reference point n in the eNB UL 204 are in the same subframe, it is necessary to make the terminal device perform signal detection ahead of time, i.e., to make the reference point n in the UE UL 203 ahead of time. Delay in the FIG. 2 is a transmission delay, i.e., the time used for signal propagation between the terminal device and the base station. The n in the UE UL 203 is advanced by an amount of one TA=2×Delay than the n in the UE DL 202, where the TA is timing advance (TA), so that the reference subframe n in the eNB DL 201 can be aligned with the reference subframe n in the eNB UL 204.

FIG. 3 is a schematic diagram of uplink and downlink timing misalignment in a base station provided by an embodiment of the present application. As shown in FIG. 3, eNB DL 301 indicates a downlink communication in a base station, eNB UL 304 indicates an uplink communication in the base station, UE DL 302 indicates a downlink communication in a terminal, UE UL 303 indicates an uplink communication in the terminal, and n is a reference point. The reference point is not located in the base station. In order to ensure that the reference point n in the eNB DL 301 and the reference point n in the eNB UL 304 are in the same subframe, it is necessary to make the terminal device perform signal detection ahead of time, i.e., to make the reference point n in the UE UL 303 ahead of time. Delay in the FIG. 3 is a transmission delay, i.e., the time used for signal propagation between the terminal device and the base station. The n in the UE UL 303 is advanced by an amount of one TA than the n in the UE DL 302, and thus the reference point n in the eNB DL 301 and the reference point n in the eNB UL 304 are not in the same subframe.

The Koffset can be applied under various operations, such as transmission of physical uplink shared channel (PUSCH) for downlink control information (DCI) scheduling; transmission of hybrid automatic repeat reQuest (HARQ) feedback information and transmission of medium access control control element (MAC CE). For certain uplink and downlink operations, the propagation delay from the terminal to the base station can also be compensated by delay compensation using round-trip time (RTT) between the terminal device and the network device (UE-eNB).

In satellite communication scenarios, the range of timing relations used may be different in different scenarios, depending on the orbital information of the satellite as well as the position information of the reference point. The range of the timing relation may be within [0 ms, 560 ms].

For the terminal of narrowband internet of things (NB-IoT), when the terminal sends a NPRACH sequence, the time position where the terminal starts a random response window (RA Response window) is determined as follows:
if the number of repeated transmissions of the NPRACH is greater than or equal to 64, a start position of the RA Response window is the last subframe n containing the repeatedly transmitted preamble+the RTT of the UE-eNB+41 ms; and
if the number of repeated transmissions of the NPRACH is less than 64, a start position of the RA Response window is the last subframe n containing the repeatedly transmitted preamble+the RTT of the UE-eNB+4 ms.

For NB-IoT devices supported in NTN scenarios, determining the start position of the RA Response window by using the RTT of the UE-eNB can, in some cases, lead to an unnecessary increase in latency.

It is to be understood that the communication system described in the embodiments of the present application is intended to more clearly illustrate the technical solutions in the embodiments of the present application and does not constitute a limitation on the technical solutions provided by the embodiments of the present application. A person of ordinary skill in the art may know that, with the evolution of the system architecture and the emergence of new business scenarios, the technical solutions provided by the embodiments of the present application are equally applicable to similar technical problems.

The methods and communication devices for determining a random access response window provided in the present application are described in detail below in conjunction with the accompanying drawings.

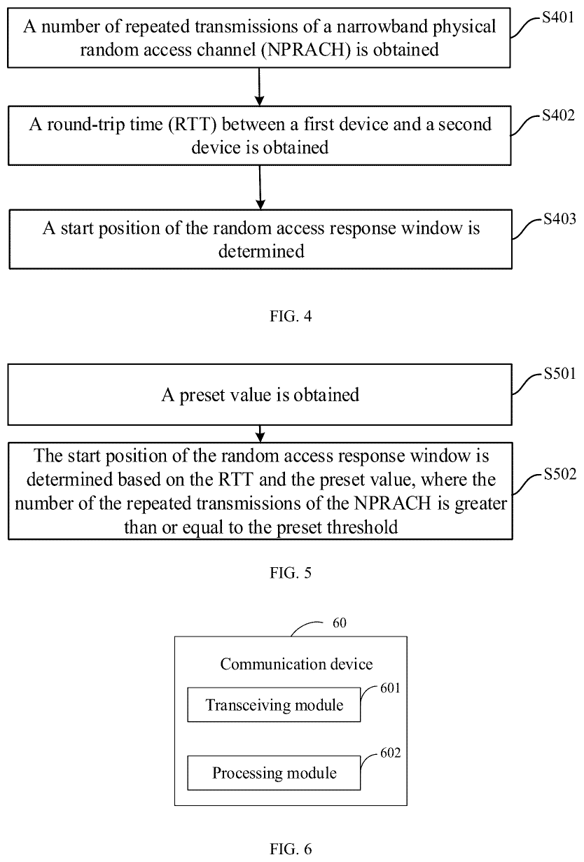

Referring to FIG. 4, FIG. 4 is a schematic flowchart of a method for determining a random access response window provided by an embodiment of the present application. The method may be applied to a terminal device. As shown in FIG. 4, the method may include, but is not limited to, the following steps.

Step S401: a number of repeated transmissions of a narrowband physical random access channel (NPRACH) is obtained.

In an embodiment of the present application, the terminal device has a global navigation satellite system (GNSS) positioning capability and is capable of determining the position of satellites through an ephemeris. The terminal device is capable of automatically estimating a timing advance (TA) when transmitting NPRACH, and performing a pre-compensation in advance to determine the start position of a RA Response window. Specifically, the terminal device can determine the start position of the random response window (RA Response window) based on the number of repeated transmissions of NPRACH. In order to extend the coverage of the signal, the NPRACH may obtain coverage enhancement by repeated propagation, and the number of repetitions may be {1, 2, 4, 8, 16, 32, 64, 128}. In a possible embodiment, with 64 radio frames as a loop, the NPRACH is transmitted on a subframe 0 in the radio frame with mod 64=0, and the same transmission content is repeatedly transmitted in subframes 0 of the next 7 consecutive radio frames, the NPRACH not being allowed to occupy the first three orthogonal frequency division multiplexing (OFDM) symbols of the subframes 0. A method for obtaining the start position of a random access response window can be determined based on the number of repeated transmissions of the NPRACH, and the method determined when the number of repeated transmissions is greater than or equal to a preset threshold and the method determined when the number of repeated transmissions is smaller than a preset threshold are different.

Step S402: a round-trip time (RTT) between a first device and a second device is obtained.

In an embodiment of the present application, as described in the background art, NTN has the benefits of wide coverage and simple network organization. However, because the NTN is limited by the quite large orbital altitude (35786 km), the satellite signal propagation delay is large and the real-time service experience is poor. In order to compensate for the transmission delay, it is also necessary to determine the start position of the random access response window (RA Response window) based on the transmission time, i.e., the RTT, of the satellite signal between the first device and the second device. In one possible embodiment, the first device is a terminal device and the second device is a network device. In another possible embodiment, the first device is a network device and the second device is a terminal device.

Step S403: a start position of the random access response window is determined.

In embodiments of the present application, after obtaining the number of repeated transmissions of the NPRACH and the RTT, a start position of the random access response window can be determined.

By implementing embodiments of the present application, the start position of the random access response window can be determined by using the number of repeated transmissions of the NPRACH and the RTT. In this way, unnecessary additional delay can be avoided, thus contributing to reducing detection overhead and avoiding resource wastage.

In an example, determining the start position of the random access response window includes:
determining the start position of the random access response window according to the RTT, where the number of the repeated transmissions of the NPRACH is less than a preset threshold.

In an embodiment of the present application, in order to extend the coverage of the signal, the NPRACH may obtain coverage enhancement by repeated propagation, and the number of repetitions may be {1, 2, 4, 8, 16, 32, 64, 128}. A preset threshold can be set to obtain a method for determining a start position of a random access response window based on the number of repeated transmissions of the NPRACH. If the number of repeated transmissions of the NPRACH is less than the preset threshold, the start position of the random access response window can be determined based on the RTT. In one possible embodiment, the preset threshold is 64, and when the number of repeated transmissions of the NPRACH is less than 64, the start position of the random access response window can be determined based on the RTT.

Referring to FIG. 5, FIG. 5 is a schematic flowchart of a method for determining a random access response window provided by an embodiment of the present application. The method may be applied to a network device. As shown in FIG. 5, the method may include, but is not limited to, the following steps:

Step S501: a preset value is obtained.

In an embodiment of the present application, the preset value is used to adjust the start position of the random access response window, the preset value being a fixed time deviation, according to which the start position of the random access response window can be determined more accurately. In one possible embodiment, the preset value is 41 milliseconds (ms).

Step S502: the start position of the random access response window is determined based on the RTT and the preset value, where the number of the repeated transmissions of the NPRACH is greater than or equal to the preset threshold.

In an embodiment of the present application, in order to extend the coverage of the signal, the NPRACH may obtain coverage enhancement by repeated propagation, and the number of repetitions may be {1, 2, 4, 8, 16, 32, 64, 128}. A preset threshold can be set to obtain a method for determining a start position of a random access response window based on the number of repeated transmissions of the NPRACH. If the number of repeated transmissions of the NPRACH is greater than or equal to the preset threshold, the start position of the random access response window may be determined based on the RTT and the preset value. In one possible embodiment, the preset threshold is 64, and when the number of repeated transmissions of the NPRACH is greater than or equal to 64, the start position of the random access response window can be determined based on the RTT and the preset value.

By implementing embodiments of the present application, the start position of the random access response window can be determined by using the number of repeated transmissions of the NPRACH, the preset value, and the RTT. In this way, unnecessary additional delay can be avoided, thus contributing to reducing detection overhead and avoiding resource wastage.

In an example, the start position of the random access response window is: subframe n+RTT, where the n is an integer.

In an embodiment of the present application, the number of the repeated transmissions of the NPRACH is less than the preset threshold, then the start position of the random access response window needs to be determined based on the RTT. In one possible embodiment, the preset threshold is 64, the number of repeated transmissions of the NPRACH is 32, the RTT is 200 ms, and the last subframe containing the repeated transmission of the NPRACH is a subframe 7, so the start position of the random access response window is the subframe 7+200 ms.

In an example, the start position of the random access response window is: subframe n+max {the RTT, the preset value}, where the n is an integer.

In an embodiment of the present application, the number of the repeated transmissions of the NPRACH is greater than or equal to the preset threshold, then the RTT and the preset value need to be compared to determine the start position of the random access response window. In one possible embodiment, the preset threshold is 64, the number of repeated transmissions of the NPRACH is 128, the RTT is 200 ms, the preset value is 41 ms, and the last subframe containing the repeated transmission of the NPRACH is a subframe 6, so the start position of the random access response window is the subframe 6+200 ms.

In another possible embodiment, the preset threshold is 64, the number of the repeated transmissions of the NPRACH is 128, the RTT is 33 ms, the preset value is 41 ms, the last subframe containing the repeated transmission of the NPRACH is a subframe 6, so the start position of the random access response window is the subframe 6+41 ms.

In an example, the last subframe containing the repeated transmission of the NPRACH is a subframe n.

In an embodiment of the present application, in order to extend the coverage of the signal, the NPRACH may obtain coverage enhancement by repeated propagation, the number of repetitions may be {1, 2, 4, 8, 16, 32, 64, 128}. In one possible embodiment, the last subframe containing the repeated transmission of the NPRACH is numbered 7, so the n=7.

In an example, the first device is a terminal device and the second device is a network device.

In an example, the first device is a network device and the second device is a terminal device.

In an embodiment of the present application, the second device is a network device if the first device is a terminal device, and the second device is a terminal device if the first device is a network device.

In the above-described embodiments provided in the present application, the methods provided in the embodiments of the present application are described from the perspective of a network device and a terminal device, respectively. In order to realize each of the above-described functions in the methods provided by the embodiments of the present application, each of the network device and the terminal device may include a hardware structure and a software module. The network device and the terminal device may realize each of the above-described functions in the form of a hardware structure, a software module, or a combination of the hardware structure and the software module. Each function of the above-described functions may be performed in the form of a hardware structure, a software module, or a combination of the hardware structure and the software module.

Referring to FIG. 6, FIG. 6 is a schematic diagram of a structure of a communication device 60 provided by an embodiment of the present application. The communication device 60 shown in FIG. 6 may include a transceiving module 601 and a processing module 602. The transceiving module 601 may include a transmitting module and/or a receiving module, the transmitting module being configured to implement a transmitting function and the receiving module being configured to implement a receiving function, and the transceiving module 601 being configured to implement the transmitting function and/or the receiving function.

The communication device 60 may be a terminal device (such as the terminal device in the preceding method embodiment), a device in a terminal device, or a device capable of being matched for use with a terminal device. In an example, the communication device 60 may be a network device, a device in a network device, or a device capable of being matched for use with a network device.

The communication device 60 is a terminal device including:
a transceiving module, configured for obtaining a number of repeated transmissions of a narrowband physical random access channel (NPRACH);
the transceiving module, further configured for obtaining a round-trip time (RTT) between the communication device and a second device; and
a processing module, configured for determining a start position of a random access response window.

In an example, the processing module, is further configured for determining the start position of the random access response window according to the RTT, where the number of repeated transmissions of the NPRACH is less than a preset threshold.

In an example, the processing module, is further configured for:
obtaining a preset value; and
determining the start position of the random access response window based on the RTT and the preset value, wherein the number of repeated transmissions of the NPRACH is greater than or equal to a preset threshold.

In an example, the start position of the random access response window is: a subframe n+the RTT, the n being an integer.

In an example, the start position of the random access response window is: a subframe n+max {the RTT, the preset value}, the n being an integer.

In an example, a last subframe comprising a repeated transmission of the NPRACH is the subframe n.

In an example, the communication device is a terminal device and the second device is a network device.

In an example, the communication device is a network device and the second device is a terminal device.

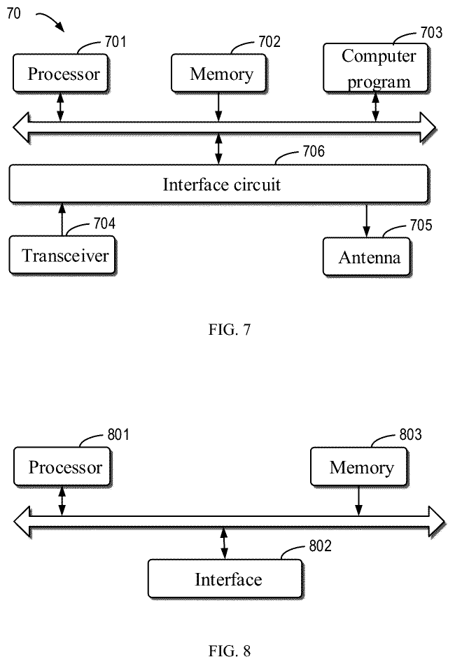

Referring to FIG. 7, FIG. 7 is a schematic structural diagram of another communication device provided by an embodiment of the present application. The communication device 70 may be a network device, a terminal device (such as the terminal device in the preceding method embodiment), a chip, a chip system, or a processor, etc., that supports the network device to realize the above-described method, or a chip, a chip system, or a processor, etc., that supports the terminal device to realize the above-described method. The device may be configured to implement the method described in the preceding method embodiments, and the details of the method may be obtained by referring to the preceding method embodiments.

The communication device 70 may include one or more processors 701. The processors 701 may be general purpose processors or specialized processors, etc. For example, it may be a baseband processor or a central processor. The baseband processor may be configured for processing communication protocols as well as communication data, and the central processor may be configured for controlling the communication device (e.g., a base station, baseband chip, terminal device, terminal device chip, DU or CU, etc.), executing a computer program, and processing data from the computer program.

In an example, the communication device 70 may also include one or more memories 702, on which a computer program 703 may be stored, and the processor 701 executes the computer program 703 to cause the communication device 70 to perform the method described in the method embodiment above. In an example, the memories 702 may also have data stored therein. The communication device 70 and the memories 702 may be provided separately or may be integrated together.

In an example, the communication device 70 may further include a transceiver 704, an antenna 705. The transceiver 704 may be referred to as a transceiver unit, a transceiving machine, or a transceiver circuit, etc., for realizing the transceiving function. The transceiver 704 may include a receiver and a transmitter, the receiver may be referred to as a receiving machine or a receiving circuit, etc., for realizing the receiving function, and the transmitter may be referred to as a transmitting machine or a transmitting circuit, etc., for realizing the transmitting function.

In an example, the communication device 70 may include one or more interface circuits 706. The interface circuits 706 are configured to receive code instructions and transmit them to the processor 701. The processor 701 runs the code instructions to cause the communication device 70 to perform the method described in the method embodiment above.

In an example, the communication device 70 is a terminal device (such as the terminal device in the preceding method embodiment). The processor 701 is configured to perform step S403 in FIG. 4. The transceiver 704 is configured to perform steps S401, S402 in FIG. 4.

In an example, the communication device 70 is a network device. The processor 701 is configured to perform step S403 in FIG. 4. The transceiver 704 is configured to perform steps S401, S402 in FIG. 4.

In one implementation, the processor 701 may include a transceiver in the processor 701 for implementing the receiving and transmitting functions. The transceiver may be, for example, a transceiver circuit, or an interface, or an interface circuit. The transceiver circuitry, interface, or interface circuitry for realizing the receiving and transmitting functions may be separate or may be integrated together. The transceiver circuit, interface, or interface circuit described above may be used for reading and writing code/data. Or, the transceiver circuit, interface, or interface circuit described above may be used for signal transmission or delivery.

In one implementation, the processor 701 may hold a computer program 703, and the computer program 703 running on the processor 701 may cause the communication device 70 to perform the methods described in the method embodiments above. The computer program 703 may be solidified in the processor 701, in which case the processor 701 may be implemented by hardware.

In one implementation, the communication device 70 may include circuit, the circuit may implement the functions of transmitting or receiving or communicating in the preceding method embodiments. The processors and transceivers described in this application may be implemented on integrated circuits (ICs), analog ICs, radio frequency integrated circuits RFICs, mixed signal ICs, application specific integrated circuits (ASICs), printed circuit boards (Printed circuit board (PCB), electronic equipment, etc. The processor and transceiver can also be manufactured using various integrated circuit (IC) fabrication technologies such as complementary metal oxide semiconductor (CMOS), nMetal-oxide-semiconductor (NMOS), positive channel metal oxide semiconductor (PMOS), bipolar junction transistor (bipolar junction transistor, BJT), bipolar CMOS (BiCMOS), silicon-germanium (SiGe), gallium arsenide (GaAs) and so on.

The communication device in the above description of embodiments may be a network device or a terminal device (such as the terminal device in the preceding method embodiment), but the scope of the communication device described in this application is not limited thereto and the structure of the communication device may not be limited by FIG. 7. The communication device may be a stand-alone device or may be part of a larger device. For example the described communication device may be:
(1) a stand-alone integrated circuit IC, or chip, or, system-on-a-chip or subsystem;
(2) a collection of ICs having one or more ICs, in an example, the collection of ICs may also include storage components for storing data, computer programs;
(3) ASICs, such as modems;
(4) modules that can be embedded in other equipment;
(5) receivers, terminal devices, intelligent terminal devices, cellular phones, wireless devices, handhelds, mobile units, in-vehicle devices, network devices, cloud devices, artificial intelligence devices, and so on;
(6) others, etc.

For the case where the communication device may be a chip or a system on a chip, see the schematic structure of the chip shown in FIG. 8. The chip shown in FIG. 8 includes processors 801 and interfaces 802. The number of the processors 801 may be one or more and the number of the interfaces 802 may be more than one.

In an example, the chip further includes a memory 803, the memory 803 being used to store necessary computer programs and data.

It will also be appreciated by those skilled in the art that the various illustrative logical blocks and steps listed in the embodiments of the present application can be implemented by electronic hardware, computer software, or a combination of both. Whether the above functions are implemented by hardware or software depends on the particular application and the design requirements of the overall system. Those skilled in the art may, for each particular application, use a variety of methods to implement the described functions, but such implementations should not be construed as being outside the scope of protection of the embodiments of the present application.

An embodiment of the present application also provides a system for determining a random access response window. The system includes a communication device as a terminal device (such as the terminal device in the aforementioned method embodiment) and a communication device as a network device in the aforementioned embodiment of FIG. 6. In an example, the system includes a communication device as a terminal device (such as the terminal device in the aforementioned method embodiment) and a communication device as a network device in the aforementioned embodiment of FIG. 7.

The present application also provides a non-transitory readable storage medium having stored thereon instructions which, when executed by a computer, realize the functions of any of the above method embodiments.

The present application also provides a computer program product which, when executed by a computer, realizes the functions of any of the above method embodiments.

In the above embodiments, the functions may be implemented in whole or in part by software, hardware, firmware, or any combination thereof. When implemented using software, it may be implemented, in whole or in part, in the form of a computer program product. The computer program product includes one or more computer programs. Loading and executing the computer program on a computer produces, in whole or in part, processes or functions in accordance with the embodiments of the present application. The computer may be a general purpose computer, a specialized computer, a computer network, or other programmable device. The computer program may be stored in a computer-readable storage medium or transmitted from one computer-readable storage medium to another computer-readable storage medium, e.g., the computer program may be transmitted from a web site, computer, server, or data center via a wired (e.g., coaxial cable, fiber optic, digital subscriber line (DSL)) or wireless (e.g., digital subscriber line (DSL)) transmission. DSL)) or wireless (e.g., infrared, wireless, microwave, etc.) to another website site, computer, server, or data center. The computer-readable storage medium may be any usable medium to which a computer has access or a data storage device such as a server, data center, etc. containing one or more usable media integrated. The usable medium may be a magnetic medium (e.g., floppy disk, hard disk, tape), an optical medium (e.g., a high-density digital video disc (DVD)), or a semiconductor medium (e.g., a solid state disk (SSD)), among others.

The person of ordinary skill in the art may understand that the first, second and other various numerical numbers involved in this application are only for the convenience of the description of the distinction, and are not used to limit the scope of the embodiments of this application, but also indicate the order of precedence.

The at least one in the present application may also be described as one or more, and the plurality may be two, three, four, or more, without limitation in the present application. In embodiments of the present application, for a technical feature, a technical feature is described by “first”, “second”, “third”, “A”, “B”, “C”, and “D”, etc., to distinguish the technical features of the technical features, the “first”, “second”, “third”, “A”, “B”, “C”, and “D”, “second”, “third”, “A”, “B”, A″, “B”, “B”, “C” and “D” describe the technical features in no order of priority or size.

The correspondences shown in the tables of this application may be configured or may be predefined. The values of the information in the respective tables are merely examples and may be configured to other values, which are not limited by this application. In configuring the correspondence between the information and the respective parameters, it is not necessarily required that all the correspondences illustrated in the respective tables must be configured. For example, the correspondences illustrated in certain rows of the tables in the present application may also not be configured. For example, it is possible to make appropriate adjustments based on the above tables, such as splitting, merging, and the like. The names of the parameters shown in the headings in the above-described tables may also be other names understandable by the communication device, and the values or representations of the parameters thereof may also be other values or representations understandable by the communication device. The above tables may also be realized using other data structures, such as arrays, queues, containers, stacks, linear tables, pointers, chain lists, trees, graphs, structures, classes, heaps, hash tables, or hash tables.

Predefined in this application may be understood as defined, pre-defined, stored, pre-stored, pre-negotiated, pre-configured, cured, or pre-fired.

One of ordinary skill in the art may realize that the units and algorithmic steps of the various examples described in conjunction with the embodiments disclosed herein are capable of being implemented in electronic hardware, or a combination of computer software and electronic hardware. Whether these functions are performed in hardware or software depends on the particular application and design constraints of the technical solution. A person skilled in the art may use different methods to implement the described functions for each particular application, but such implementations should not be considered outside the scope of this application.

It is clearly understood by those skilled in the field to which it belongs that, for the convenience and brevity of the description, the specific working processes of the above-described systems, devices, and units can be referred to the corresponding processes in the foregoing embodiments of the method, and will not be repeated herein.

The above mentioned are only specific implementations of the present application, but the scope of protection of the present application is not limited thereto, and any person skilled in the art who is familiar with the technical field can easily think of changes or substitutions within the technical scope disclosed in the present application shall be covered by the scope of protection of the present application. Therefore, the scope of protection of the present application shall be subject to the scope of protection of the stated claims.

1. A method for determining a random access response window, comprising:
obtaining a number of repeated transmissions of a narrowband physical random access channel (NPRACH);
obtaining a round-trip time (RTT) between a first device and a second device; and
determining a start position of the random access response window.

2. The method according to claim 1, wherein determining the start position of the random access response window comprises:
determining the start position of the random access response window according to the RTT, wherein the number of repeated transmissions of the NPRACH is less than a preset threshold.

3. The method according to claim 1, wherein determining the start position of the random access response window comprises:
obtaining a preset value; and
determining the start position of the random access response window based on the RTT and the preset value, wherein the number of repeated transmissions of the NPRACH is greater than or equal to a preset threshold.

4. The method according to claim 2, wherein the start position of the random access response window is: a subframe n+the RTT, the n being an integer.

5. The method according to claim 3, wherein the start position of the random access response window is: a subframe n+max{the RTT, the preset value}, the n being an integer.

6. The method according to claim 4, wherein a last subframe comprising a repeated transmission of the NPRACH is the subframe n.

7. The method according to claim 1, wherein the first device is a terminal device and the second device is a network device.

8. The method according to claim 1, wherein the first device is a network device and the second device is a terminal device.

9-16. (canceled)

17. A communication device, comprising:
a memory; and
one or more processors that are communicatively coupled to the memory, wherein the one or more processors are collectively configured to:
obtain a number of repeated transmissions of a narrowband physical random access channel (NPRACH),
obtain a round-trip time (RTT) between a first device and a second device, and
determine a start position of a random access response window.

18. A communication device comprising:
one or more processors; and
an interface circuit,
wherein the interface circuit is configured to receive code instructions and transmitting the code instructions to at least one of the one or more processors;
wherein the one or more processors are collectively configured to:
obtain a number of repeated transmissions of a narrowband physical random access channel (NPRACH),
obtain a round-trip time (RTT) between a first device and a second device, and
determine a start position of a random access response window.

19. A non-transitory computer-readable storage medium storing instructions, the instructions when the instructions executed by a processors, cause the processor to execute the method according to claim 1.

20. The method according to claim 5, wherein a last subframe comprising a repeated transmission of the NPRACH is the subframe n.

21. The communication device according to claim 17, wherein the start position of the random access response window is determined by:
determining the start position of the random access response window according to the RTT, wherein the number of repeated transmissions of the NPRACH is less than a preset threshold.

22. The communication device according to claim 17, wherein the start position of the random access response window is determined by:
obtaining a preset value; and
determining the start position of the random access response window based on the RTT and the preset value, wherein the number of repeated transmissions of the NPRACH is greater than or equal to a preset threshold.

23. The communication device according to claim 21, wherein the start position of the random access response window is: a subframe n+the RTT, the n being an integer.

24. The communication device according to claim 22, wherein the start position of the random access response window is: a subframe n+max{the RTT, the preset value}, the n being an integer.

25. A wireless system for determining a random access response window, the system comprising the communication device according to claim 17.

26. A non-transitory computer program product comprising a computer program which, when executed by a computer, causes the computer to perform the method according to claim 1.

27. A chip system, comprising: at least one processor and interfaces, the chip system being configured to perform the method according to claim 1.

28. A non-transitory computer program which, when executed by a computer, causes the computer to perform the method according to claim 1.
